(19) United States
(12) Patent Application Publication
(10) Pub. No.: US 2002/0180993 A1
(43) Pub. Date: Dec. 5, 2002

(54) Identification card printer having multiple controllers

(76) Inventors: Gary M. Klinefelter, Eden Prairie, MN (US); Leonid S. Gershenovich, Eden Prairie, MN (US); Gary A. Lenz, Eden Prairie, MN (US); Robert E. Francis, Richfield, MN (US)

Correspondence Address: WESTMAN, CHAMPLIN & KELLY, A PROFESSIONAL ASSOCIATION, INTERNATIONAL CENTRE, 900 SECOND AVENUE SOUTH, SUITE 1600, MINNEAPOLIS, MN, 55402-3319, US

(21) Appl. No.: 10/126,428

(22) Filed: Apr. 19, 2002

Related U.S. Application Data
(63) Continuation-in-part of application No. 09/564,519, filed on May 4, 2000.
(60) Provisional application No. 60/133,003, filed on May 7, 1999.

(51) Int. Cl. B41J 1/00; G06F 15/00

(52) U.S. Cl. 358/1.1; 358/1.15

(57) ABSTRACT

An identification card printer includes a communications bus, first and second card processing devices, and first and second controllers. The first and second controllers are coupled to the communications bus and are each identified by a unique address. The first and second controllers are adapted to control the first and second card processing devices, respectively, in response to command signals received over the communications bus.

### CROSS REFERENCE TO RELATED APPLICATIONS

The present invention is a Continuation-in-Part of U.S. patent application Ser. No. 09/564,519, entitled “PRINTER WITH DISTRIBUTED COMPUTER MODULAR ARCHITECTURE,” for inventors Ted J. Pillera, Robert E. Francis, Matthew K. Dunham and Gary M. Klinefelter, filed May 4, 2000, which in turn claims priority to U.S. Provisional Application Serial No. 60/133,003, filed May 7, 1999 and entitled “PRINTER WITH DISTRIBUTED COMPUTER MODULAR ARCHITECTURE.”Additionally, reference is hereby made to the following related co-pending applications filed on even date herewith: application Ser. No. ______, entitled “IDENTIFICATION CARD PRINTER,” for inventors Martin A. Pribula, James R. Meier, Stacy W. Lukaskawcez, Gary M. Klinefelter, Leonid S. Gershenovich, Gary A. Lenz, and Jeffrey D. Upin, having Attorney Docket Number F12.12-0110; application Ser. No. ______, entitled “CARD CARTRIDGE,” for inventors Martin A. Pribula, James M. Meier, Stacy W. Lukaskawcez, Anthony L. Lokken, Gary M. Klinefelter, Gary A. Lenz and Jeffrey D. Upin, having Attorney Docket Number F12.12-0111; application Ser. No. ______, entitled “CARD TRANSPORT MECHANISM ROLLER SUPPORT,” for inventors Martin A. Pribula and Gary M. Klinefelter, having Attorney Docket Number F12.12-0112; application Ser. No. ______, entitled “CARD CARTRIDGE AND CARD FEEDER ADAPTER FOR AN INK JET SHEET FEEDER PRINTER,” for inventors Gary M. Klinefelter, Martin A. Pribula, Leonid S. Gershenovich and Stacy W. Lukaskawcez, having Attorney Docket Number F12.12-0113; and application Ser. No. ______, entitled “IDENTIFICATION CARD PRINTER DATA ENCODER MODULE,” for inventors Darrell T. Olson and Matthew K. Dunham, having Attorney Docket Number F12.12-0115. All of the above-referenced applications are incorporated herein by reference in their entirety.

### BACKGROUND OF THE INVENTION

The present invention relates generally to identification card printers. More specifically, the present invention relates to an identification card printer having multiple controllers that are each adapted to control a card processing device of the printer.

Identification card printers along with the aid of a computer are typically used to form identification cards. Identification card printers are distinguishable from conventional paper printers due to the number of separate functions they perform in producing an identification card. In addition to having a print mechanism for printing on a card and a transport mechanism for feeding cards through the printer, identification card printers can include a magnetic encoder for magnetically encoding data on a magnetic strip of the card, a smart card encoder for encoding data to a chip mounted to the card, laminators for laminating a surface of the card, a card flipper for flipping the card, and other card processing devices.

Conventionally, identification card printers include a single controller that controls the operation of the card processing devices of the printer in response to command signals from a personal computer (PC). This single controller configuration renders the printer difficult to modify or upgrade. For example, it is generally not possible for a user to replace a printhead of a printer with another printhead produced by a different manufacturer than that of the original printhead due to an incompatibility between the printer's controller and the new printhead. Furthermore, the capabilities of the controller are generally limited to the features of the printer that the controller was designed to control. In other words, a controller that is not initially configured to control an add-on, or a replacement card processing device of the printer, such as a magnetic encoder module, would need to be replaced prior to adding such a component to the printer. As a result, conventional single controller identification card printers are difficult and costly to upgrade or modify.

There is a continuing need for improvements to identification card printers including improvements that make it easy to upgrade existing components, or modify the identification card printer by adding new components.

### SUMMARY OF THE INVENTION

The present invention is directed to an identification card printer having multiple controllers, which render the printer easier to upgrade and modify than conventional identification card printers having a single controller. The identification card printer includes a communications bus, first and second card processing devices, and first and second controllers. The first and second controllers are coupled to the communications bus and are each identified by a unique address. The first and second controllers are adapted to control the first and second card processing devices, respectively, in response to command signals received over the communications bus.

Other features and benefits that characterize embodiments of the present invention will be apparent upon reading the following detailed description and review of the associated drawings.

### BRIEF DESCRIPTION OF THE DRAWINGS

FIGS. 1 and 2 are schematic diagrams of identification card printers in accordance with embodiments of the present invention.

FIG. 3 is a schematic diagram of an identification card printer illustrating various card processing components, in accordance with embodiments of the invention.

FIG. 4 is a flowchart illustrating the steps of processing a print job in accordance with an embodiment of the invention.

### DETAILED DESCRIPTION OF THE PREFERRED EMBODIMENTS

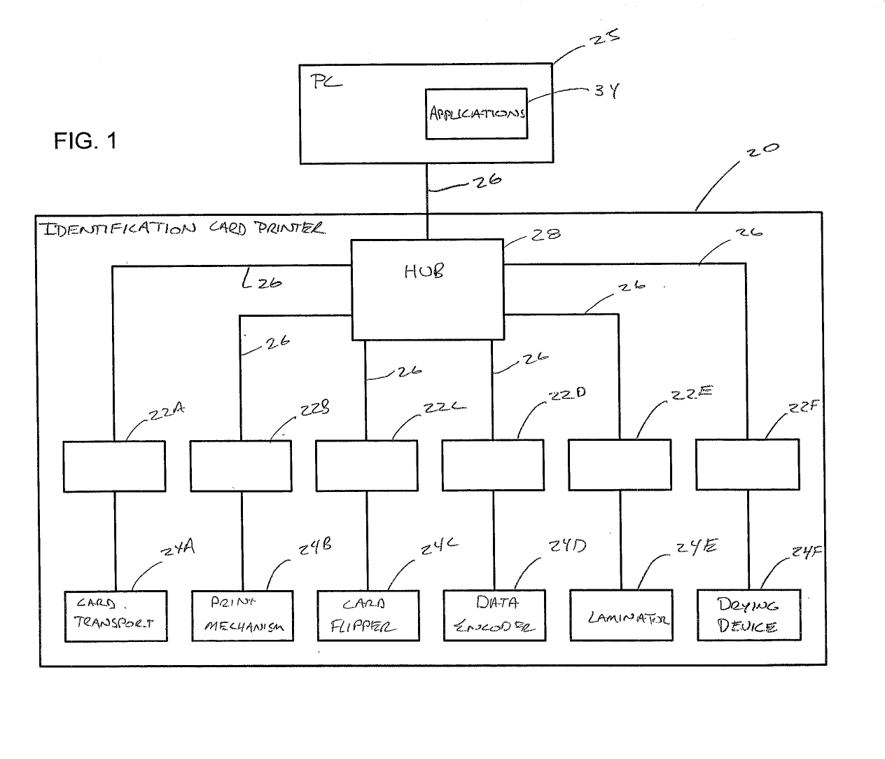

The present invention relates to an identification card printer 20, illustrated schematically in FIG. 1. Printer 20 includes multiple controllers 22A-F (referred to generally as 22), each of which are adapted to control the operations of at least one associated card processing device 24A-F (referred to generally as 24) of printer 20.

A personal computer (PC) 25 connects to printer 20 through a communications bus 26, that is preferably a Universal Serial Bus (USB) or the like. Controllers 22 are coupled to bus 26 through a hub 28 or other data switching component. Each controller 22 includes a unique network address which allows PC 25 to direct command signals and data to a particular controller 22 over communications bus 26. In a similar manner, the individual controllers 22 can be configured to communicate with PC 25 and other controllers 22 connected to the bus 26.

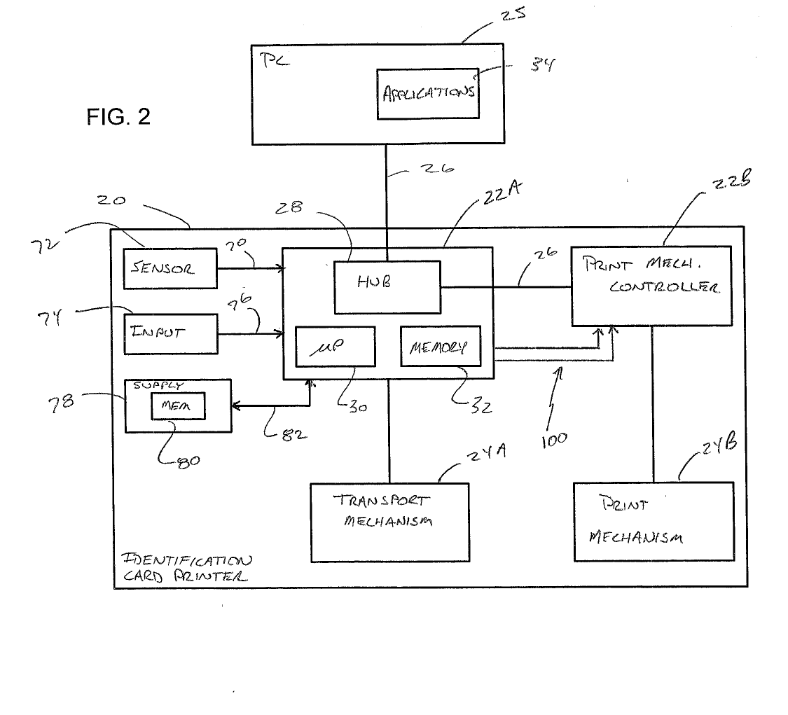

Each controller 22 can include a microprocessor 30 and memory 32, as shown in controller 22A of FIG. 2. Memory 32 can include software applications that are executable by microprocessor 30 and data that is accessible by microprocessor 30. This allows each controller 22 to control the corresponding card processing device 24 independently of the other controllers 22. As a result, the architecture of identification card printer 20 allows for multiple tasks to be performed by card processing devices 24 simultaneously.

PC 25 includes at least one software application 34 that is used to generate the command signals and communicate them to printer 20 over bus 26 in accordance with conventional protocols. The command signals are addressed to specific controllers 22 and are directed thereby using hub 28. The command signals also include instructions and data that are used by the controllers 22 to control their corresponding card processing device 24 to perform the desired function.

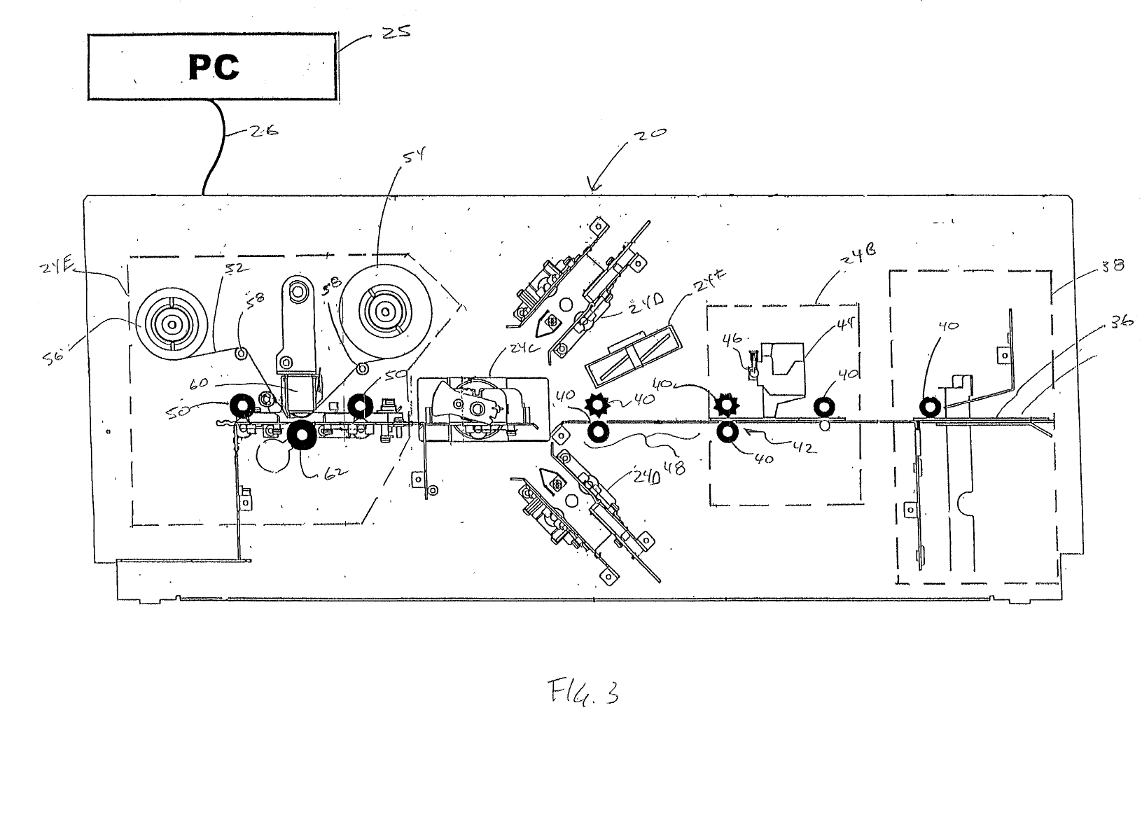

In accordance with one embodiment of the invention, card processing devices 24 of printer 20 can include a card transport mechanism 24A, a print mechanism 24B, a card flipper 24C, a data encoder 24D, a laminator 24E, and a drying device 24F, as shown in the schematic diagram of FIG. 3. Card transport mechanism 24A, under the control of controller 22A, is generally configured to receive cards 36 from a card holder or a card cartridge 38 and transport the cards 36 along a card path to print mechanism 24B for printing. Transport mechanism 24A is further configured to deliver cards 36 to other card processing devices 24 of printer 20. Transport mechanism 24A generally includes feed and guide rollers 40 that form pinch roller assemblies 42 for feeding the cards 36 along the print path.

Print mechanism 24B is depicted as an ink jet printhead having an ink jet cartridge 44. Print mechanism 24B can also be a thermal printhead in combination with a thermal print ribbon, or other suitable print mechanism. Print mechanism 24B is generally moved back and forth along a rail 46 in a direction that is transverse to the card path along which transport mechanism 24A feeds cards 36. Print mechanism 24B is controlled by controller 22B to print image lines on cards 36 that are presented in a print position by transport mechanism 24A to form the desired image on a surface of card 36.

After the printing on card 36 is completed, transport mechanism 24A can move the card 36 into a drying/holding area 48 where drying device 24F, under the control of controller 22F, operates to accelerate the drying of ink on card 36. Drying device 24F can be a fan, a heater, a combination fan and heater, a heated roller, or other suitable drying device.

Once the desired drying of card 36 is completed, feed rollers 40 of transport mechanism 24A can deliver card 36 into card flipper 24C. Card flipper 24C is controlled by controller 22C to selectively flip card 36 or present card 36 to either the upper or lower data encoders 24D. Data encoders 24D are controlled by controller 22D to encode data to a card 36 that is provided by card flipper 24C. Data encoders 24D can be magnetic encoders that are adapted to encode data magnetically to a magnetic portion or strip of card 36. Alternatively, data encoders 24D can be smart card chip encoders that are adapted to encode data to a smart card chip mounted to card 36.

Following the encoding of card 36, card flipper 24C can present card 36 to laminator 24E. Laminator 24E is controlled by controller 22E to laminate a surface of card 36. Laminator 24E includes transport rollers 50 that are used to move card 36 through laminator 24E. An overlaminate material 52 is moved between a supply roll 54 and a take-up roll 56 past rollers 58 and heater 60. A platen 62 is provided to press card 36 against overlaminate 52 and heater 60 to laminate one surface of card 36. Card 36 may be fed back into card flipper 24C for flipping card 36 to allow the other side of card 36 to be laminated by laminator 24E.

In accordance with one embodiment of the invention, printer 20 includes only first and second controllers 22A and 22B that are coupled to communication bus 26, as shown in FIG. 2. Here, first controller 22A is a card transport controller adapted to control the card transport mechanism 24A and second controller 22B is a print mechanism controller adapted to control print mechanism 24B. Additional card processing devices 24, such as those described above, can be added along with a corresponding controller if necessary.

First and second controllers 22A and 22B control their corresponding devices 24A and 24B in response to command signals directed to their addresses that are received over communications bus 26. Hub 28 directs the command signals to the various controllers 22 in accordance with address information contained in the command signal. In accordance with one embodiment, hub 28 is formed as a component of first controller 22A, which allows first controller 22A to prevent command signals from reaching their intended destination. This allows first controller 22A to essentially disable the operations of printer 20.

First controller 22A can also receive output signals 70 from one or more sensors 72, such as a card sensor, to assist in the transporting of cards 36 through printer 20. Sensors 72 can be infrared sensors, mechanical sensors, or other types of sensors. Printer 20 can also include a user interface having one or more input devices 74, such as buttons and switches, that allow a user of printer 20 to provide user input commands 76 to first controller 22A. Additionally, printer 20 can include a supply 78, such as a card supply, an ink cartridge, overlaminate supply, or other print consumable, that includes a supply circuit 80. Supply circuit 80 includes memory for containing supply information relating to the supply. In accordance with one embodiment, first controller 22A is adapted to communicate with supply circuit 80 through a suitable physical or wireless connection 82.

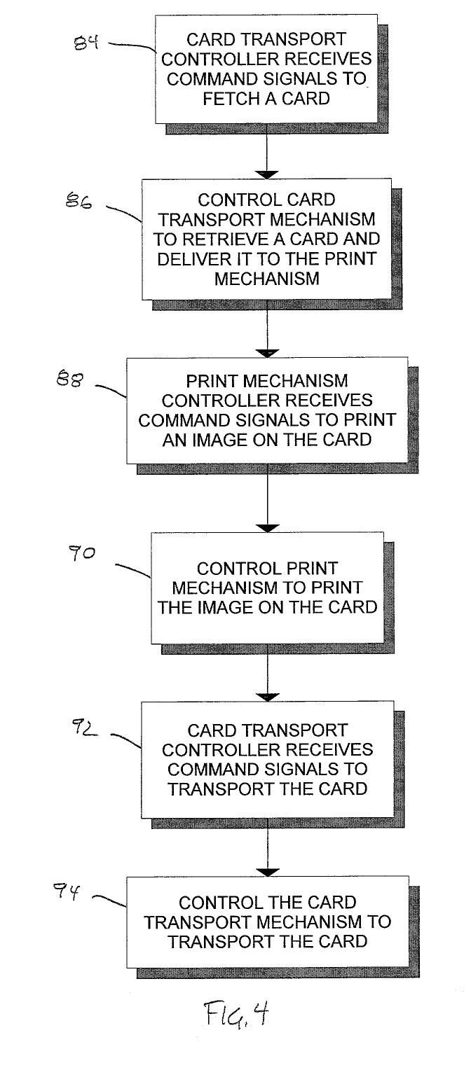

In operation, software application 34 generates a print job that generally includes a sequence of command signals containing instructions and data that are delivered to particular controllers 22 of printer 20 to complete the processing of the print job. FIG. 4 is a simplified flowchart illustrating a series of steps that could be implemented to process such a print job. At step 84, command signals are received by card transport controller 22A to fetch a card 36 from card holder 38. At step 86, card transport controller 22A controls card transport mechanism 24A to retrieve a card 36 from card holder 38 and deliver the card 36 to print mechanism 24B. Next, at step 88, command signals are directed to print mechanism controller 24D to print an image onto a surface of the card 36. Print mechanism controller 22B then controls print mechanism 24B to print the image on the card 36, at step 90. At step 92, command signals directed to card transport controller 24A provide instructions for further transport of card 36 along the print path to either another card processing device 24, such as drying device 24F or to eject the card from identification card printer 20. Finally, at step 94, card transport controller 22A controls card transport mechanism 24A to transport the card accordingly. It should be understood that the command signals could be provided to the controllers 22A and 22B in a single transmission where the controllers control the corresponding card processing devices to perform the desired functions either independently with the aid of appropriate sensors, or by way of communication between controllers 22A and 22B.

In accordance with another embodiment of the invention, printer 20 is originally configured for operation with only printer controller 22B and can be, for example, an ink jet sheet feed printer. The printer is then modified or retrofitted to operate as an identification card printer or manufacturing device by modifying an original paper feed mechanism to operate as card transport mechanism 24A and by adding card transport controller 22A, which operates as a primary controller of printer 20. One or more sensors 72 and input devices 74 that originally provided output signals 70 and input commands 76 to controller 22B, are rerouted to provide the output signals 70 to controller 22A, as shown in FIG. 2. The output signals 70 and input commands 76 can then be relayed to controller 22B either through a communication over bus 26 or directly as indicated at 100 in FIG. 2. For example, signals 100 may provide an infrared signal, a voltage signal, or operate a switch, in accordance with the original configuration of the printer. As a result, controller 22A can be essentially “piggy-backed” on to original controller 22B without modifying to controller 22B to form the identification card printer 20.

Although the present invention has been described with reference to preferred embodiments, workers skilled in the art will recognize that changes may be made in form and detail without departing from the spirit and scope of the invention. For example, although communications bus 26 has been described as a USB, communications bus 26 can be any type of suitable data communications link such as parallel cable, serial cable, network cable, a wireless communication link (infrared or radio frequency). Furthermore, the communication protocol can be unidirectional or bi-directional in accordance with a standard communication protocol including network based techniques such as Ethernet and other data communication techniques.

What is claimed is:

1. An identification card printer comprising:
a communications bus;
first and second card processing devices; and
first and second controllers coupled to the communications bus, the first and second controllers each identified by a unique address and adapted to respectively control the first and second card processing devices in response to command signals received over the communications bus.

2. The printer of claim 1, including a communications hub connected to the communication bus for switching command signals in accordance with the address to which they are directed.

3. The printer of claim 2, wherein the first controller is adapted to control the operation of the hub.

4. The printer of claim 1, wherein the card processing devices include a print mechanism, a card flipper, a card transport mechanism, a smart card encoder, a magnetic encoder, or a laminator.

5. The printer of claim 1, wherein the first controller is adapted to control a card transport mechanism and the second controller is adapted to control a print mechanism.

6. The printer of claim 1, including a third controller adapted to control a card processing device.

7. The printer of claim 6, wherein the card processing device is a card flipper, a smart card encoder, a magnetic encoder, or a laminator.

8. The printer of claim 1 including a user interface electrically coupled to the first controller, the user interface providing user input commands to the first controller.

9. The printer of claim 8, wherein the user interface includes buttons that generate the user input commands.

10. The printer of claim 1, including a card sensor positioned to detect transported cards, the card sensor including an output signal electrically coupled to the first or second controller.

11. The printer of claim 1, wherein the communications bus is a universal serial bus (USB).

12. The printer of claim 1, including:
a supply circuit mounted to a supply and having a memory for storing supply information; and
a communication circuit adapted to communicate with the supply circuit.

13. The printer of claim 12, wherein the communications circuit is a component of the first controller.

14. The printer of claim 12, wherein the supply is an ink jet cartridge, a thermal print ribbon, a card cartridge, or an overlaminate.

15. An identification card printer comprising:
a communications bus;
a card supply;
a print mechanism;
a card transport mechanism for transporting cards from the card supply to the print mechanism;
a first controller coupled to the communication bus and having a unique address, the first controller adapted to control the card transport mechanism in response to command signals received over the communication bus; and
a second controller coupled to the communication bus and having a unique address, the second controller adapted to control the print mechanism in response to command signals received over the communication bus.

16. The printer of claim 15, including a communications hub connected to the communication bus for switching command signals in accordance with the network address to which they are directed.

17. The printer of claim 16, wherein the first controller is adapted to control the operation of the hub.

18. The printer of claim 15, wherein the first controller is further adapted to control at least one additional card processing device.

19. The printer of claim 18, wherein the card processing device is a card flipper, a smart card encoder, a magnetic encoder, or a laminator.

20. The printer of claim 15, including a third controller adapted to control a card processing device.

21. The printer of claim 20, wherein the card processing device is a card flipper, a smart card encoder, a magnetic encoder, or a laminator.

22. The printer of claim 15 including a user interface electrically coupled to the first controller, the user interface providing user input commands to the first controller.

23. The printer of claim 22, wherein the user interface includes buttons that generate the user input commands.

24. The printer of claim 15, including a card sensor positioned to detect transported cards, the card sensor including an output signal electrically coupled to the first controller.

25. The printer of claim 15, wherein the communications bus is a universal serial bus (USB).

26. The printer of claim 15, including:
a supply circuit mounted to a supply and having a memory for storing supply information; and
a communication circuit adapted to communicate with the supply circuit.

27. The printer of claim 26, wherein the communications circuit is a component of the first controller.

28. The printer of claim 26, wherein the supply is an ink jet cartridge, a thermal print ribbon, a card cartridge, or an overlaminate.

29. An identification card printing system comprising:
the identification card printer of claim 15; and
a computer coupled to the communications bus, the command signals produced by printer driver software running on the computer.

30. An identification card printer comprising:
a communications bus;
an original printer controller adapted to control a print mechanism in response to command signals over the communications bus; and
a card transport controller that is piggy-backed to the original printer controller and controls a card transport mechanism in response to command signals over the communications bus.

31. The identification card printer of claim 30, wherein:
the printer includes at least one sensor having an output signal that was originally directed to the printer controller; and
the card transport controller is configured to receive the output signal and relay the output signal to the printer controller.
